(19) United States
(12) Patent Application Publication
(10) Pub. No.: US 2005/0143126 A1
(43) Pub. Date: Jun. 30, 2005

(54) Electronic device

(75) Inventor: Jan Chipchase, Tokyo (JP)

Correspondence Address: HARRINGTON & SMITH, LLP, 4 RESEARCH DRIVE, SHELTON, CT, 06484-6212, US

(73) Assignee: Nokia Corporation

(21) Appl. No.: 10/748,873

(22) Filed: Dec. 29, 2003

(51) Int. Cl. H04M 1/00

(52) U.S. Cl. 455/557

(57) ABSTRACT

An electronic device is used to read metadata carried by an image carrier which carries a printed image, such as a photograph. The device, which may be a cellular telephone, interprets the metadata to identify an instruction for the device, such as an instruction to make a telephone call. Thus, for example, the device may interact with the image carrier to make a telephone call to the individual who is the subject of the photograph.

### BACKGROUND OF THE INVENTION

The present invention relates to electronic devices and in particular, but not exclusively, to hand portable electronic devices such as cellular telephones, personal digital assistants (PDAs) and the like.

Hand portable electronic devices exist in many forms. Examples include cellular telephones, personal organisers and PDAs. It is becoming increasingly common for these devices to be used for storing and viewing images, particularly digital photographs. Cellular telephones are used to allow digital photographs to be shared between users. In addition, cellular telephones may include a digital camera or an interface for connection with a digital camera, to allow a telephone user to capture an image and store it or send it to another individual. Images which have been stored on the telephone may be downloaded to another device, particularly a home or office computer to which the user has access, allowing image archiving and cataloguing to be undertaken by appropriate application software on the computer.

### BRIEF SUMMARY OF THE INVENTION

The present invention provides an electronic device comprising:
data reading means operable to read metadata carried by an image carrier which carries a printed image;
interpretation means operable to interpret the metadata to identify an instruction for operation of the device; and
execution means operable to cause the device to execute an instruction identified by the interpretation means.

Preferred features of this aspect of the invention are set out in the appended claims, to which reference should now be made.

In another aspect, the invention provides an image system comprising:
image means operable to receive data representing an image;
metadata means operable to generate metadata able to be interpreted to identify an instruction for an electronic device, and to associate the metadata with the image data;
data output means operable to output image data and associated metadata for generating a printed image which incorporates the metadata in a form readable by the electronic device.

Preferred features of this aspect of the invention are set out in the appended claims, to which reference should now be made.

In a third aspect, the invention provides a document bearing a printed image and incorporating machine readable metadata associated with the image, the metadata representing an instruction for operation of an electronic device.

Preferred features of this aspect of the invention are set out in the appended claims, to which reference should now be made.

In a fourth aspect, the invention provides a method of creating a printed image in which:
metadata is generated, the metadata identifying an instruction for an electronic device;
an association is formed between the metadata and data representing an image; and
the image data and associated metadata are output for generating a printed image which incorporates the metadata in a form readable by the electronic device.

Preferred features of this aspect of the invention are set out in the appended claims, to which reference should now be made.

In a fifth aspect, the invention provides a user interface by which a user instructs a device to print an image, the interface comprising:
display means operable to provide a display for use by a user to select metadata for association with the image; and
processor means operable in response to a user selection to output image data and associated metadata for generating a printed image which incorporates the metadata in a form readable by a predetermined electronic device.

Preferred features of this aspect of the invention are set out in the appended claims, to which reference should now be made.

Examples of the present invention will now be described in more detail, and by way of example only, with reference to the following drawings, in which:

### BRIEF DESCRIPTION OF THE DRAWINGS

FIG. 1 is a diagrammatic representation of an electronic device;

FIG. 2 is a diagrammatic representation of a document for use with the device of FIG. 1, in accordance with the present invention;

FIG. 3 is a flow diagram of the use of the document of FIG. 2 with the device of FIG. 1;

FIG. 4 is a diagrammatic representation of the manner in which the document of FIG. 2 is produced, in accordance with the present invention; and

FIG. 5 is a diagram of a dialog box for a user interface used in the process of FIG. 4

### DETAILED DESCRIPTION OF THE DRAWINGS

User Device

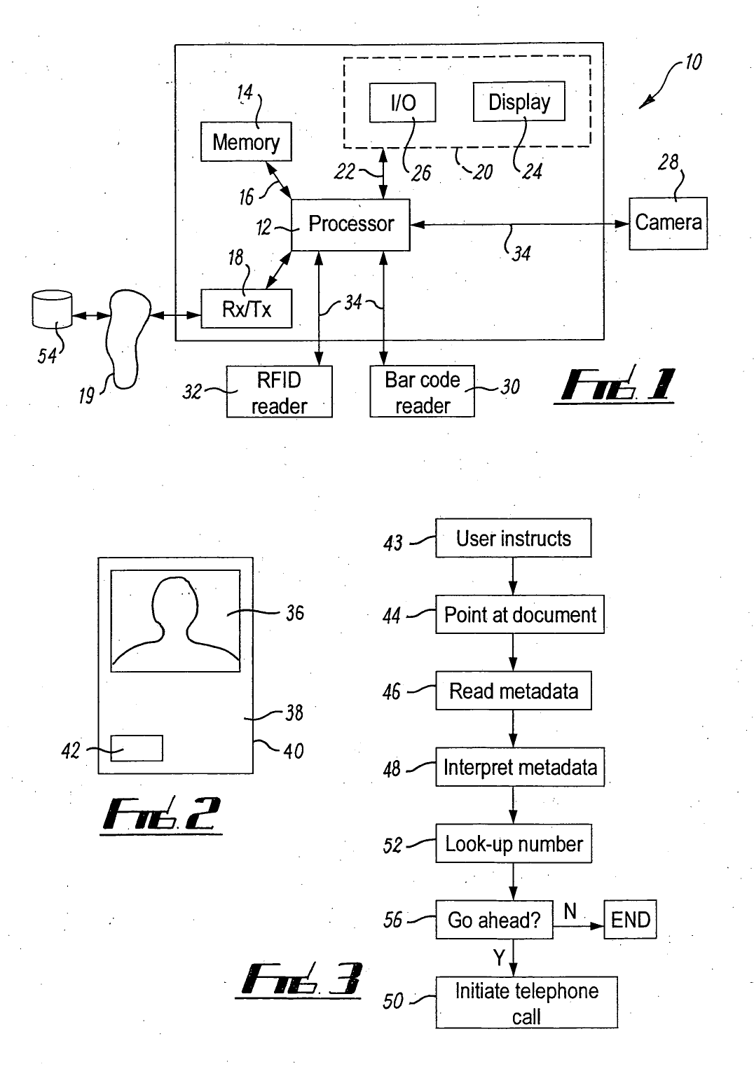

The first example of the invention, to be described, is implemented by means of a hand portable electronic device 10, illustrated in FIG. 1. In this example, the device 10 is in the form of a cellular telephone but could alternatively be a personal organiser, PDA or other hand portable electronic device.

The telephone 10 includes a processor 12 which controls the functions of the telephone in accordance with software stored in memory 14, with which the processor 12 is in communication at 16. The memory 14 also includes data which the processor 12 may require during use, such as lists of telephone numbers. The processor 12 is in communication with radio transceiver apparatus 18 which, in use, establishes two-way communication between the telephone 10 and a cellular telephone network 19.

User operation of the telephone 10 is provided by a user interface 20 in communication with the processor at 22 and including at least a display 24 and appropriate input and output apparatus 26, such as a loudspeaker, microphone and keyboard.

Three further components are illustrated in FIG. 1, namely a camera 28, a bar code reader 30 and a reader 32 for radio frequency identification devices (commonly known as “RFID tags”). Appropriate software control would allow the camera 28 also to function as a bar code reader. Each of the items 28, 30, 32 may be a module having a separate housing from the telephone 10 and connected with the processor 12 by means of an appropriate interface 32 or alternatively, one or more of the components 28, 30, 32 may be built into the housing of the telephone 10.

FIG. 2 illustrates a printed image 36, with which the telephone 10 can be used, in accordance with the present invention.

The image 36 is printed on an image carrier 38 to produce a printed document 40 from which the image 36 may be viewed.

The document 40 also incorporates metadata at 42. In this specification, the term “metadata” refers to data which has relevance to primary data (image data, in this example), but is not itself part of the primary data, or necessary for the primary data to be complete in relation to its principal purpose (in this example, the production of a viewable image).

The manner in which the document 40 is created will be described below. At this stage, it is sufficient to note that the metadata 42 consists of, or includes data which is sufficient to identify an instruction for operation of the telephone 10.

The term “image” is used throughout this specification, because the preferred manner of implementing the invention is in relation to visual images, particularly photographs. However, it is to be understood that the image 36 on the document 40 could, alternatively, be a passage of text, or other material.

Interaction with Printed Document

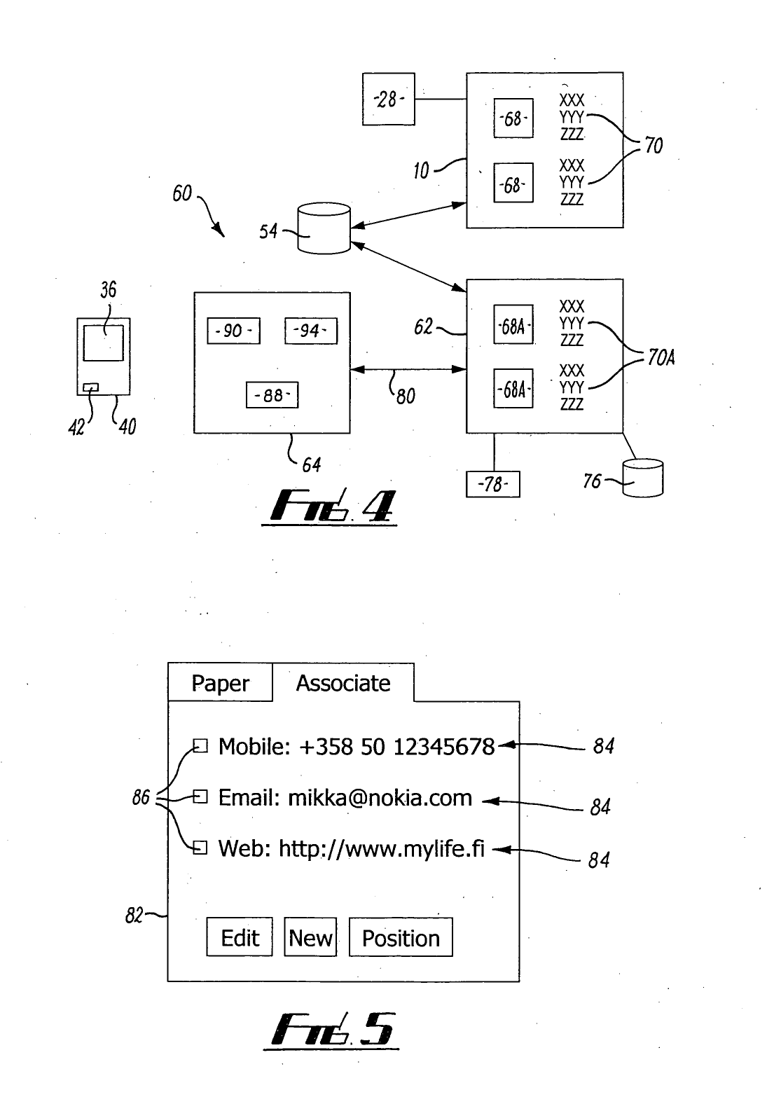

In accordance with the present invention, the telephone 10 can interact with the document 40, in a sequence of steps set out in FIG. 3.

The process is initiated by a user at 43 issuing an appropriate instruction to the processor 12, by means of the interface 20. The telephone 10 and the document 40 are also brought together at 44. Although step 44 is illustrated in FIG. 3 as following step 43, either may follow the other, or both may be executed simultaneously.

The device 10 and document 40 are brought together to allow the appropriate device 28, 30, 32 to read the metadata 42. Thus, if the metadata 42 is in the form of a bar code, the bar code reader 30 is brought to an appropriate position to read the metadata. Alternatively, if the metadata 42 is in the form of an RFID tag, the RFID reader 32 is brought to an appropriate position to read the metadata contained within the tag 42.

In a further alternative, the camera 28 may be used to read metadata 42, either in bar code form or other visible form. Thus, an appropriate optical device, such as the camera 28 or bar code reader 30 is used if the metadata 42 is in visible form. Alternatively, the metadata 42 may be in invisible but machine readable form, such as data in an RFID tag, in which case, an alternative reader, such as the RFID reader 32 would be used. It will be readily apparent to the skilled reader that many other formats for the metadata 42 could be envisaged and that any could be used if the telephone 10 is equipped with an appropriate data reading device.

The metadata is read at step 46.

After receiving the metadata 42, the processor 12 executes appropriate software to function as an interpretation device to interpret the metadata (step 48). In particular, the processor 12 seeks to interpret the metadata 42 to identify an instruction for operation of the telephone 10. This interpretation may be achieved in various ways. For example, the metadata 42 may include sufficient data for the telephone 10 to identify an individual shown in the image 36, or to whom the image 36 is considered relevant. This may be by including the individual's name in the metadata 42, or an abbreviated name or other identifier.

Metadata which identifies an individual may be interpreted at 48 as an instruction to the telephone 10 to initiate communication with that individual, by making a telephone call by means of the transceiver 18.

The telephone call is initiated at step 50. Prior to that, if the metadata 42 identifies the individual but does not include the appropriate telephone number, it may be necessary for the processor 12 to interrogate information held in the memory 14 to retrieve the telephone number or alternatively, the processor 12 may initiate a telephone call through the transceiver 18 to retrieve an appropriate telephone number by interrogation of a database 54 at a remote location.

The sequence may also include an optional step 56 in which the processor 12 requests a confirmation instruction from the telephone user at 56, confirming that the telephone call should be initiated at 50. If communication in more than one manner is possible in the light of the interpretation of the metadata, such as a telephone call, text (SMS) message, e-mail etc., step 56 will preferably include a step in which the user selects the mode of communication to be used. This interaction with the user is achieved by means of the interface 20.

Thus, it can be seen that after reading the metadata 42, the processor 12 has operated to interpret the metadata to identify an instruction for operation of the telephone 10. In this example, the metadata is interpreted as an instruction to initiate a telephone call with the individual identified by means of the metadata. The processor 12 has then operated to cause the telephone 10 to execute the instruction, by initiating the telephone call at 50.

Alternative Arrangements

Many alternatives to the arrangements just described may be envisaged. The metadata 42 may include a complete telephone number, e-mail address or other contact details to be used at step 50, or an identifier which allows a telephone number to be obtained, either from the memory 14 or from the remote database 54. The former alternative is advantageous in allowing any telephone equipped as described to execute the instruction by recovering the appropriate telephone number from the metadata 42. The second alternative is advantageous in making additional use of information stored in the memory 14 or database 54. The metadata 42 is not required to incorporate all of the information which will be used to execute the instruction, but only sufficient information to allow the necessary further information to be retrieved when required.

The interpretation of the metadata, as described above, depends in part on the context in which the metadata is interpreted. Thus, as described above, the metadata is being interpreted by a telephone 10. Consequently, once a telephone number or other contact details have been recovered from the metadata, or sufficient information has been recovered to allow a telephone number or other contact detail to be obtained from previously stored information, this information is interpreted by the telephone as an instruction to initiate communication with the individual identified. The instruction is thus partially predetermined, requiring only the contact details of the individual to be provided, in order to complete the instruction. In the case of an alternative device being used, such as a PDA, in which communication functions are not necessarily incorporated, the metadata may be interpreted in other ways. For example, a PDA may interpret the identification of an individual from metadata as an instruction to display information included in the diary held by the PDA such as the next appointment with that individual, or all future appointments. Again, the instruction is partly predetermined, but requires the individual to be identified. In the case of other devices, different actions relevant to the particular device may be executed, once the metadata has been interpreted. Thus, in any of these cases, the metadata may include the complete instruction to the device, or alternatively, the metadata may include information to complete the formulation of an instruction which is partially predetermined. In a further alternative, the metadata may contain only an identifier, such as an identifier for the corresponding image, but no instruction or personal data. In this example, the identifier is used to interrogate information previously stored in the device or in the database 54. The identifier allows a corresponding instruction or personal data to be retrieved, for use as described above.

It will be readily apparent that the invention described above can also be implemented in a multi-function portable device, such as a device which can operate as a cellular telephone and a PDA, for example. In that case, it may be appropriate to use a user interface to allow a user to select an operation to be performed, such as one of a range of partially predetermined actions relevant to respective functions of the device.

Creation of Printed Documents

The remaining drawings can be used to describe the manner of production of a printed document of the type shown in FIG. 2, for use as described above.

FIG. 4 illustrates an imaging system 60 used to generate a document 40 having a printed image 36 and machine readable metadata 42, as described above. The system 60 includes at least one device which can receive data representing an image. In this example, the device may be a hand portable electronic device such as the telephone 10 described above in relation to FIG. 1, or a computer 62. Both devices are shown schematically in FIG. 4 as simple outlines.

The system also includes a printer or other document creation device operable to create the document 40 on receiving data from the telephone 10 or computer 62.

One of the devices 10, 62 is first used to receive data representing images which are ultimately to be printed in the document 40. In the case of a telephone 10, the image data may be captured by the camera 28 or received by means of the transceiver 18 (not shown in FIG. 4), or may be retrieved from memory. FIG. 4 illustrates two images 68 which have been received by the telephone 10 and are stored within the telephone 10. The telephone 10 also stores blocks of metadata at 70, each block of metadata 70 relating to a corresponding image 68. The metadata 70 may include information which is automatically generated, such as data relating to the time or date on which the image 68 was created, or the camera type, camera settings and other photographic detail. In addition, the telephone 10 will have access to data identifying the location of the telephone 10 at the time the image 68 was captured, in accordance with conventional cellular telephone operation. Consequently, location information can be incorporated in the metadata 70. In a further example, image recognition software may be used to analyse the image 68 and derive additional metadata, such as the identity of a subject or location. In the event that an individual is identified in this way, the telephone 10 may extract a telephone number, e-mail address or other contact information from the telephone memory 14 for incorporation in the metadata 70.

All of the metadata just described may be created automatically by operation of appropriate software within the telephone 10. Additional metadata may be created manually by a user using the interface. Manually created metadata may provide a title for the corresponding image 68, or identify a group to which it belongs, for example identifying the image as taken during a particular event or at a particular place, or with a particular person as subject. The user interface 20 preferably facilitates the entry of manual metadata by displaying existing group names or names of individuals drawn from information stored in the telephone memory 14, for selection by the user. Consequently, selection by the user of an appropriate individual will also allow the metadata 70 to include contact details such as a telephone number, e-mail address or the like, drawing this additional information from the telephone memory 14.

In the alternative example, using the computer 62, the computer 62 is used to receive data representing images 68A and to store these along with metadata 70A, in a manner similar to that just described. However, it is envisaged that the computer 62 will be able to receive image data from a wider range of sources, which may include images downloaded from databases or internet sites 76, or images downloaded from a camera or other image capture device 78. Furthermore, images 68A may be downloaded from the telephone 10, either with the metadata 70, or prior to the creation of metadata.

It is envisaged that a computer 62 will have more computing power available than a telephone, for running software for storing and organising images and collections of images, including the creation of additional metadata of the types mentioned above.

Thus, the devices 10, 62 are used to generate metadata and associate the metadata with the image data 68, 68A.

Additional metadata may be created by operation of the user interface 20, or an equivalent user interface provided on the computer 62. The interface may be configured particularly as illustrated in FIG. 5, in the form of a dialog box used as part of the process for printing the document 40. This process can now be described, as follows.

When the user instructs the device 10, 62 to print an image, the user interface of FIG. 5 (provided by the user interface 20 in the telephone 10, or a corresponding user interface of the computer 62) presents a dialog box 82 to the user, as part of the print routine. The dialog box 82 is produced partly in dependence on the metadata 70, 70A already associated with the image 68, 68A. For example, if the metadata identifies an individual whose contact details are available to the device 10, 62, the contact details are displayed in the dialog box 82 at 84, with each component having an associated box 86. Manipulation of a cursor, in known manner, allows a user to check one or more of the boxes 86. In this way, the user expresses a preference, thereby selecting additional information to be incorporated within the metadata associated with the image being printed. Thus, a user may check the uppermost box 86 to indicate that a telephone number is to be incorporated into the metadata. A processor associated with the interface (such as the processor 12 of the telephone 10) processes user preferences expressed by means of the dialog box 82, to incorporate the additional information into the metadata.

Data representing the image 68, 68A is then sent to the printer 64, along with the associated metadata 70, 70A, as modified through the dialog box 82. FIG. 2 only illustrates data being sent from the computer 62, in the interests of clarity. In an alternative, only a subset of the metadata 70, 70A is sent to the printer. The rest of the metadata 70, 70A is stored locally, or sent to the server 54. For example, an identifier may be produced manually or automatically to identify the image, and is sent to the printer as the metadata to be incorporated in the document. The remainder of the metadata 70, 70A is stored for retrieval when the identifier is recovered from the document, as described above.

In a further alternative, a two dimensional image may be produced by “electronic ink”, such as that produced by E Ink Corporation of Cambridge, Mass., USA, to allow the image on the document 40 to be dynamic rather than static.

The metadata 70, 70A may be updated when a change is made through the dialog box 82, for future use. It is also envisaged that a default setting may be incorporated within the user interface so that a default selection of one or more boxes 86 will be made, unless modified by the user. These features improve the ease with which printing is achieved on the first and subsequent occasions.

The printer 64 receives the image data and prints this at 36 onto the image carrier 38, in a conventional manner. In addition, the printer 64 incorporates the metadata (or a subset of it, as described above) into the document 40, as follows.

In one example, the printer 64 includes a bar code processor 88 which selects the metadata and processes it to form a bar code image which encodes the metadata. This bar code is then printed onto the document 40, to provide the metadata 42 at a position either within or outside the image 36. The bar code metadata may be printed on the reverse of the document 40, with an appropriately adapted printer. The bar code may be a one-dimensional or two-dimensional bar code.

This results in a document 40 which includes the printed image 36 and also includes the metadata 42 in bar code encoded form. The bar coded metadata can therefore be read by a device in the manner described in relation to FIGS. 1 to 3, in order to be interpreted as an instruction for the reading device, such as to initiate communication with the individual or telephone number identified by the metadata.

In an alternative arrangement, the printer 64 is adapted to incorporate metadata into the document 40 in invisible but machine readable form, by means of RFID tags. An RFID tag may be incorporated into the image carrier 38 on manufacture, such as by attachment to the surface or embedding within the material of the carrier 38. For this type of image carrier, a writer device 90 is incorporated within the printer 64 to allow the printer 64 to write the metadata to the RFID tag of the image carrier 38 on which the associated image 36 is printed.

The metadata is thereafter available for reading from the document 40 by an appropriate RFID reader, such as the reader 32 of the telephone 10.

In an alternative, the printer 64 may include a dispenser 92 for RFID tags, one of which is dispensed when a document 40 is printed. The RFID writer 90 is used to write the metadata to the RFID tag. The printer 64 may then automatically attach the RFID tag to the document 40 or alternatively, the RFID tag may be provided in the form of an attachable component for the user to affix to the document 40. For example, the RFID tag could be a self-adhesive component.

In a further alternative, the RFID tag may be manufactured with a unique identifier, such as an identifying number. In this alternative, the printer 64 will include an RFID tag reader 94 so that the identifying number of a dispensed tag can be read. This identifier is returned at 96 to the instructing device 10, 62 to be recorded as part of the metadata 70, 70A.

The result of any of these alternatives is a document 40 which bears a printed image 36 and also carries metadata 42, encoded in an RFID tag. Accordingly, a device such as a telephone 10 can read the RFID tag metadata in the manner described above in relation to FIGS. 1 to 3. If the complete metadata is incorporated in the RFID tag, the reading device can recover all of the data directly from the document 40. In an alternative, the reading device may recover only the identifier of the RFID tag or the image and use this to search for the associated metadata 70, 70A to which that identifier relates. Alternatively, the metadata, the identifier and the association between them may be recorded in the server 54. This has the advantage that any reader device having access to the server 54 can have access to the metadata identified by the identifier, without requiring access to the metadata stored in the device which instructed the printer 64.

It is envisaged that the cost of an RFID tag will be relatively high compared with the cost of suitable paper for use as the image carrier 38. Consequently, it is preferred that the operating sequence of the printer 64 results in the RFID tag being produced after the image 36 has been fully printed. This ensures that if paper jams in the printer, for example, a relatively expensive RFID tag is not wasted. It is preferred that the RFID tag is affixed to the reverse side of the image carrier 38, whether manually or automatically by the printer 64. In either alternative, the RFID tag is preferably designed so that it is not visually intrusive to a viewer of the image 36. In a further alternative, the RFID tag may be embedded within the paper during manufacture, but this will increase the cost of the paper and thus increase the cost of failed print operations. While it is envisaged that the whole of the metadata can be written to an RFID tag incorporated in the document 40, the alternative in which the metadata is stored at a server 54 has the advantage that the data at the server can be updated (for example if a telephone number changes) more readily than data within an RFID tag, so that the information contained within an RFID tag is less likely to become out of date. The server 54 will maintain a correct association with current personal data.

The description set out above has related primarily to 2 dimensional images. It is envisaged that the principles of the invention can also be applied to other information. In particular, it is envisaged that the image data may be in the form appropriate to generate a three dimensional object, rather than a 2 dimensional image. Thus, the document printer 64 would be replaced with a device for creating three dimensional objects (sometimes called a 3D printer, and manufactured, for example, by Z Corporation of Burlington, Mass., USA). Metadata would be incorporated into the three dimensional object, for subsequent use in ways which are the same as, or analogous with those described. Thus, terms such as “image”, “document”, “print”, which are commonly assumed to refer to two dimensional concepts, should be understood herein to include also at least three dimensional concepts.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. An electronic device comprising:
data reading means operable to read metadata carried by an image carrier which carries a printed image;
interpretation means operable to interpret the metadata to identify an instruction for operation of the device; and
execution means operable to cause the device to execute an instruction identified by the interpretation means.

2. A device according to claim 1, wherein the device is a hand portable electronic device.

3. A device according to claim 2, wherein the device is a multi-function portable device.

4. A device according to claim 2, wherein the device is operable as a cellular telephone.

5. A device according claim 1, wherein the execution means is operable to cause the device to initiate communication in response to an identified instruction.

6. A device according to claim 1 wherein the interpretation means is operable, in use, to recover personal data from the metadata.

7. A device according to claim 6, wherein the personal data recovered by the interpretation means includes at least one of a name, telephone number and contact details.

8. A device according to claim 6, wherein the execution means is operable in response to an identified instruction to initiate communication with an individual identified by the personal data.

9. A device according to claim 6, wherein the execution means is operable to add the personal data to the memory of the device, if not already contained therein.

10. A device according to claim 1, wherein the data reading means is an optical device which responds to metadata carried in visible form by the image carrier.

11. A device according to claim 10, wherein the visible metadata is carried in the form of a bar code.

12. A device according to claim 1, wherein the data reading means is a non-optical device operable to detect metadata carried in machine readable form by the image carrier.

13. A device according to claim 12, wherein the machine readable metadata is provided by a radio frequency identification device.

14. A device according to claim 1, wherein the interpretation means is operable to retrieve an instruction contained within the metadata.

15. A device according to claim 14, wherein the interpretation means interprets a retrieved instruction by reference to further stored interpretation data.

16. A device according to claim 15, wherein the interpretation means is operable to receive metadata from the data reading means, in the form of an identifier, and uses the further stored interpretation data to recover an instruction identified by the identifier.

17. A device according to claim 15, wherein the further stored interpretation data is stored remotely, the interpretation means being operable to communicate with the remote location to enable the interpretation means to use the further stored interpretation data.

18. An image system comprising:
image means operable to receive data representing an image;
metadata means operable to generate metadata able to be interpreted to identify an instruction for an electronic device, and to associate the metadata with the image data;
data output means operable to output image data and associated metadata for generating a printed image which incorporates the metadata in a form readable by the electronic device.

19. A system according to claim 18, wherein the electronic device for which an instruction is incorporated is a hand portable electronic device.

20. A system according to claim 19, wherein the electronic device is a multi-function portable device.

21. A system according to claim 18, wherein the device is operable as a cellular telephone.

22. A system according to claim 18 wherein the metadata means is operable in response to a user input to generate metadata.

23. A system according to claim 18, wherein the metadata means is operable to retrieve stored data for incorporation into the metadata.

24. A system according to claim 18, wherein the metadata means is operable to incorporate data representing the conditions in which the image has been captured.

25. A system according to claim 18, wherein the metadata means is operable to incorporate at least one of time data, date data, location data and operating settings of data capture means used to capture the represented image.

26. A system according to claim 18, wherein the metadata means is operable to analyse a represented image to identify a subject therein, and to provide data representative of the subject, for incorporation into the metadata.

27. A system according to claim 18, wherein the metadata means is operable to perform a selection of stored data from a stored data set, the selection being performed in dependence on data to be incorporated into the metadata, to recover additional data for incorporation.

28. A system according to claim 18, wherein the metadata is sufficient for the electronic device to identify an individual for the purpose of initiating communication with that individual.

29. A system according to claim 28, wherein the metadata contains personal data.

30. A system according to claim 29, wherein the personal data includes at least one of the name, telephone number and contact details of an individual.

31. A system according to claim 18, incorporated within a cellular telephone.

32. A system according to claim 18, further comprising printer means operable to receive data representing an image, and associated metadata, and to generate a printed image which incorporates the metadata.

33. A system according to claim 32, wherein the metadata is incorporated within the image area of the printed image.

34. A system according to claim 33, wherein the metadata is incorporated in encoded form.

35. A system according to claim 32, wherein the metadata is incorporated in an optically readable form.

36. A system according to claim 35, wherein the metadata is incorporated in the form of a bar code.

37. A system according to claim 32, wherein the metadata is incorporated in non-optical machine readable form.

38. A system according to claim 37, wherein the metadata is contained within a radio frequency identification device which is physically associated with the image carrier upon which the image is printed.

39. A system according to claim 32, wherein the metadata is written to a member which is initially separate from the image carrier on which the image is printed, and is attachable thereto.

40. A system according to claim 32, wherein the metadata contains the instruction.

41. A system according to claim 32, wherein the metadata contains sufficient information to identify the instruction by reference to further stored interpretation data.

42. A system according to claim 32, wherein the metadata includes an identifier usable to recover an instruction identified by the identifier.

43. A document bearing a printed image and incorporating machine readable metadata associated with the image, the metadata identifying an instruction for operation of an electronic device.

44. A method of creating a printed image in which:
metadata is generated, the metadata identifying an instruction for an electronic device;
an association is formed between the metadata and data representing an image; and
the image data and associated metadata are output for generating a printed image which incorporates the metadata in a form readable by the electronic device.

45. A user interface by which a user instructs a device to print an image, the interface comprising:
display means operable to provide a display for use by a user to select metadata for association with the image; and
processor means operable in response to a user selection to output image data and selected metadata for generating a printed image which incorporates the metadata in a form readable by a predetermined electronic device.
